(19) United States
(12) Patent Application Publication
(10) Pub. No.: US 2005/0027940 A1
(43) Pub. Date: Feb. 3, 2005

(54) Methods and apparatus for migrating a temporary memory location to a main memory location

(76) Inventors: Vincent J. Zimmer, Federal Way, WA (US); William A. Stevens, Folsom, CA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/633,432

(22) Filed: Aug. 1, 2003

(51) Int. Cl. G06F 12/00

(52) U.S. Cl. 711/117; 711/118

(57) ABSTRACT

Methods and apparatus to migrate a temporary memory location to a main memory location are disclosed. In one example, a disclosed method may include copying the content from the temporary memory location to the main memory location, calculating a migration factor between the temporary memory location and the main memory location and modifying a value in main memory that identifies the temporary memory location to identify the main memory location.

### TECHNICAL FIELD

The present disclosure is directed generally to computer systems and, more particularly, to methods and apparatus to migrate a temporary memory location to a main memory location.

### BACKGROUND

Modern computing systems include a processor and one or more external memories that must be initialized in the early stages of processor startup before a processor has loaded an operating system (OS). One problem is that external memory such as random access memory (RAM), which may be implemented using synchronous dynamic RAM (SDRAM), rambus dynamic RAM (RDRAM), double data rate SDRAM (DDR SDRAM), etc., has a long initialization process during which the RAM cannot be used. Accordingly, any processes that are executed by the computing system during startup cannot use external RAM to store variables, data, or any other constructs.

Due to the fact that external memory (e.g., RAM) is unavailable during pre-boot, most pre-boot code is written in assembly language that utilizes processor registers, rather than external memory. In contrast to pre-boot code, much of the available OS runtime software is written in a high level language, such as the C programming language. Unlike assembly code, code written in a high level language requires external memory to operate. For example, the C programming language uses external memory to maintain a stack and a heap. As will be readily appreciated by those having ordinary skill with the art, a stack is an information repository that stores program execution history and local data structures, and the heap is an information repository that stores dynamically allocated data structures (i.e. storage that is not known until the program is running).

As is known to those having ordinary skill in the art, code written in assembly language has many weaknesses. First, assembly code is complex to program because it is written at the machine level. Second, assembly code is not portable (e.g., assembly code written to run on an Intel® processor would have to be re-written to operate on another vendor's processor). Third, assembly language restricts a developer to using only hardware registers, and, therefore, has very little data storage capacity. Fourth, assembly languages are difficult to learn, because the syntax for the language is different for every platform on which a developer creates code. As will be readily appreciated, these weaknesses result in poor development productivity and brittleness (i.e., even a small and seemingly benign change to the assembly code can break the whole system) of programs written in assembly language.

Realizing the foregoing advantages of high level languages and the unavailability of external memory, some pre-boot code is written in high level languages in which the code is tricked into thinking an on-board processor cache, which is quickly initialized on processor reset, is an external memory in which program elements such as a stack and a heap may be stored. However, the processor cache may be flushed when the external (or main) memory becomes available, resulting in the loss of crucial state information and data stored in, for example, a stack and a heap. As will be readily appreciated by those having ordinary skill in the art, it is difficult to write high level language that can operate in spite of state and data loss that occur upon cache flush. Taking such care when using high level language drastically affects the benefits of using the same. Accordingly, some developers continue to write pre-boot code in assembly, as opposed to writing the code in a carefully-constructed high level language arrangement.

### BRIEF DESCRIPTION OF THE DRAWINGS

FIG. 1 is a functional block diagram of an example code execution system including the ability to migrate stored information from a temporary memory to a main memory.

FIG. 2 is a block diagram of an example computing system on which the code execution system of FIG. 1 may be implemented.

FIG. 3 is a block diagram of an example memory map representing the processor mapping memories of the computing system of FIG. 2.

FIG. 4 is a flow diagram of an example pre-boot process that may be carried out by the computing system of FIG. 2.

FIG. 5 is a flow diagram of an example migrate storage process that may be carried out by the computing system of FIG. 2.

### DETAILED DESCRIPTION

The following describes example methods, apparatus, and articles of manufacture that provide a code execution system having the ability to migrate stored information. While the following disclosure describes systems implemented using software or firmware executed by hardware, those having ordinary skill in the art will readily recognize that the disclosed systems could be implemented exclusively in hardware through the use of one or more custom circuits, such as, for example, application-specific integrated circuits (ASICs) or any other suitable combination of hardware and/or software.

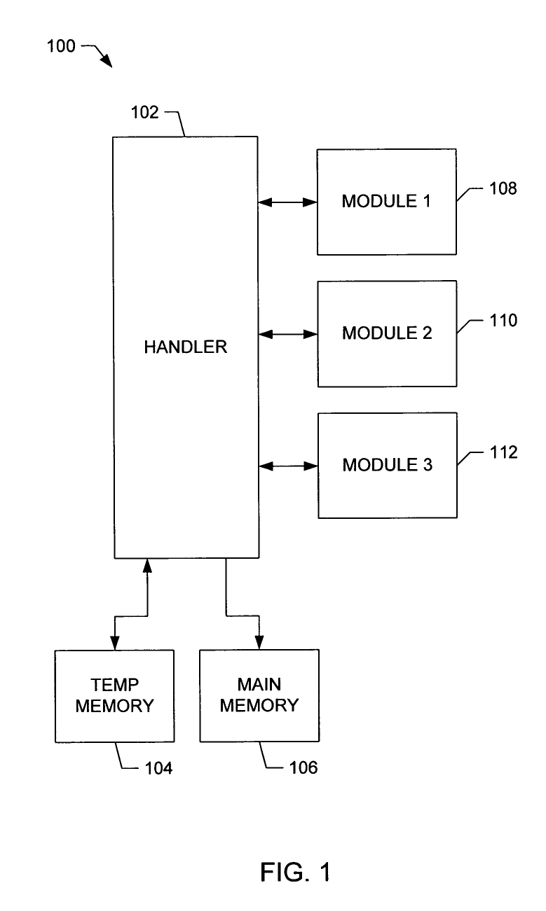

In FIG. 1, an example code execution system 100 includes a handler 102, a temporary memory device (temp memory) 104, a main memory device 106, and three example code modules: module 1 108, module 2 110, and module 3 112. The handler 102, the temp memory 104, and three example code modules: module 1 108, module 2 110, and module 3 112 may be, for example, components contained on or executed by the processor.

The handler 102 may be implemented by code executing on a processor. The handler 102 controls access to temp memory 104 and main memory 106. As described in detail below, handler 102 also controls migration of stored information from the temp memory 104 to the main memory 106 after initialization of the main memory 106 is complete.

The temp memory 104 may be, for example, an L1 cache, which is on the same chip as the processor. In the alternative, temp memory 104 may be implemented as an L2 cache, on a separate chip, such as, for example, on static RAM (SRAM).

The main memory 106 may be a memory device external to the processor. For example, the main memory 106 may be implemented using RAM, such as SDRAM, RDRAM, DDR SDRAM, or the like, in which data and instructions are stored and retrieved. In the alternative, the main memory 106 may be implemented using any other memory device. The data stored in the main memory 106 may be arbitrarily complex and may, for example, take the form of a stack and/or a heap.

The modules 108, 110, 112 may be binary images resulting from a compiled high level language like the C programming language. The modules 108, 110, 112 may be, for example, binary images of drivers or other software firmware that may be executed in the pre-boot environment. The execution of the modules 108, 110, 112 is coordinated by the handler 102. Of course, as will be readily appreciated by those having ordinary skill in the art, more modules than those shown in FIG. 1 may be invoked by the handler 102.

As described below, during operation the handler 102 coordinates the execution of the modules 108, 110, 112 such that prior to main memory 106 initialization, data constructs (such as a stack and/or a heap, etc.) are stored in the temp memory 104. When the main memory 106 initialization is complete, the handler 102 transfers the data constructs on other information (e.g., a stack and/or a heap) to the main memory 106. After the data constructs are moved to the main memory 106, the processor will continue to use the main memory 106 to hold the constructs during execution.

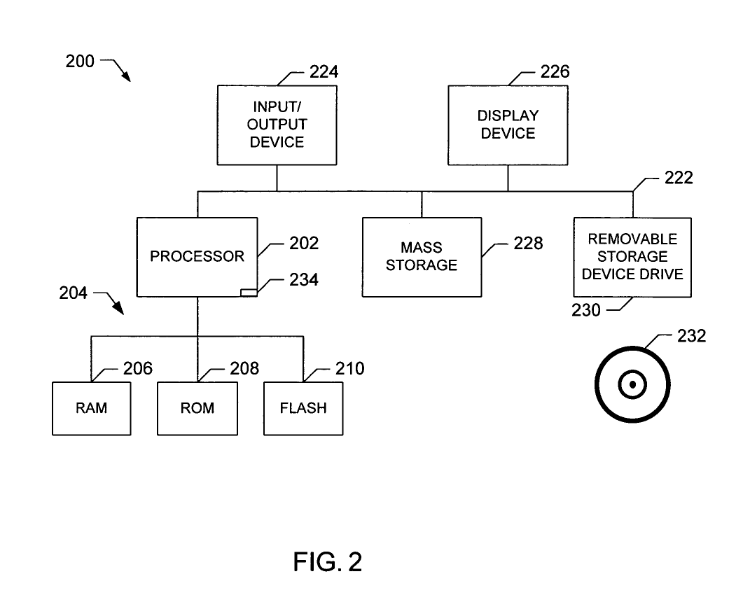

Turning now to FIG. 2, an example processor system 200 on which the disclosed processes may be executed includes a processor 202 having associated memory 204, which may be implemented using, for example, RAM 206 (in which the main memory 106 of FIG. 1 may be implemented), read only memory (ROM) 208 and/or flash memory 210. The processor 202 is coupled to an interface, such as a bus 222, to which other components may be interfaced. In the illustrated example, the components interfaced to the bus 222 include an input/output device 224, a display device 226, a mass storage device 228, and a removable storage device drive 230. The removable storage device drive 230 may include associated removable storage media 232, such as magnetic or optical media.

The example processor system 200 may be, for example, a conventional desktop personal computer, a notebook computer, a workstation or any other computing device. The processor 202 may be any type of processing unit, such as a microprocessor from the Intel® Pentium® family of microprocessors, the Intel® Itanium® family of microprocessors, and/or the Intel XScale® family of processors. The processor 202 may include a cache 234 that implements the temp memory 104 of FIG. 1. As previously noted, the temp memory 104 of FIG. 1 may be, for example, L1 cache (as shown in FIG. 2), or L2 cache. The memories 206, 208 and 210 that are coupled to the processor 202 may be any suitable memory devices, and may be sized to fit the storage demands of the system 200. In particular, the flash memory 210 may be a non-volatile memory that is accessed and erased on a block-by-block basis.

The input/output device 224 may be implemented using a keyboard, a mouse, a touch screen, a track pad, or any other device that enables a user to provide information to the processor 202. Alternatively or additionally, the input output device 224 may be a network connection that couples data to and from the processor 202.

The display device 226 may be, for example, a liquid crystal display (LCD) monitor, a cathode ray tube (CRT) monitor or any other suitable device that acts as an interface between the processor 202 and a user. The display device 226 as pictured in FIG. 2 includes a peripheral device required to interface a display screen to the processor 202.

The mass storage device 228 may be, for example, a conventional hard drive or any other magnetic or optical media that is readable by the processor 202.

The removable storage device drive 230 may be, for example, an optical drive, such as a compact disk-recordable (CD-R) drive, a compact disk-rewritable (CD-RW) drive, a (DVD) drive or any other optical drive. It may alternatively be, for example, a magnetic media drive. The removable storage media 232 is complimentary to the removable storage device drive 230, inasmuch as the media 232 is selected to operate with the drive 230. For example, if the removable storage device drive 230 is an optical drive, the removable storage media 232 may be a CD-R disk, a CD-RW disk, a DVD disk or any other suitable optical disk. On the other hand, if the removable storage device drive 230 is a magnetic media device, the removable storage media 232 may be, for example, a diskette or any other suitable magnetic storage media.

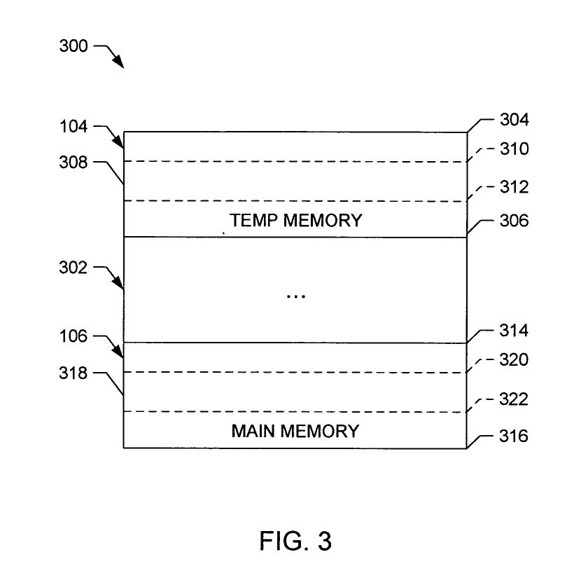

The RAM 206 and the cache 234 may be memory mapped to the processor 202 so that the processor 202 knows how to access the same. One example of a memory map is shown in FIG. 3. In general, as shown in FIG. 3, the temp memory 104, which may be the cache 234, may be mapped to a position that is above the main memory 106, which may be the RAM 206, when intervening memory 302 is mapped between the temp memory 104 and the main memory 106.

The area of the temp memory 104 is defined by a top of temp memory location 304 and a bottom of temp memory location 306. As shown in phantom relief in FIG. 3, a temp memory heap storage area 308 is demarcated by a top of heap temp memory location 310 and a bottom of heap temp memory location 312. The temp memory heap storage area 308 may be used as a storage repository for components associated with high level language code, such as a heap for dynamic data storage.

Although the temp memory 104 and the main memory 106 are shown at the top and bottom of the of the memory map 300, those having ordinary skill in the art will readily recognize that the temp memory 104 and the main memory 106 may be located anywhere within the memory map 300. Furthermore, although the temp memory 104 is shown as being above the main memory 106 in FIG. 3, such an arrangement is not the only possible arrangement. For example, the main memory 106 may be mapped to a location above the temp memory 104. Additionally, the intervening memory 302 may be eliminated from the memory map 300, thereby leaving the temp memory 104 adjacent the main memory 106.

The area of main memory 106 is defined by a top of main memory location 314 and a bottom of main memory location 316. As shown in phantom relief in FIG. 3, a main memory heap storage area 318 is demarcated by a top of heap main memory location 320 and a bottom of heap main memory location 322. The main memory heap storage area 318 may be used as a storage repository for components associated with high level language code, such as a heap for dynamic data storage after the main memory 106 has been initialized.

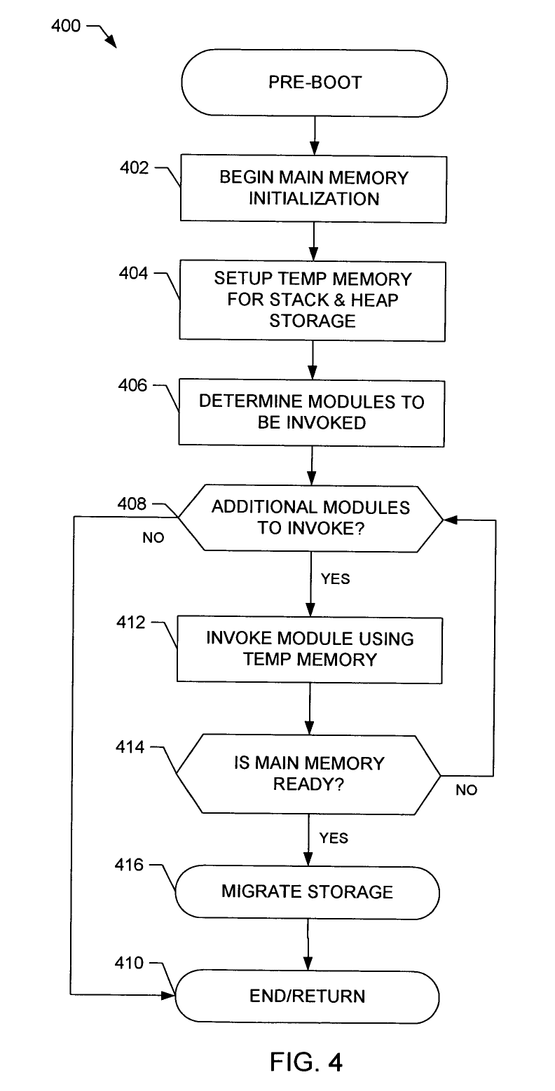

A pre-boot process 400, as shown in FIG. 4, may be stored in a processor boot block that may be located within the flash memory 210. The pre-boot process 400 may be implemented using one or more software programs or sets of instructions that are stored in one or more memories (e.g., the memories 206, 208, 210) and executed by one or more processors (e.g., the processor 202). However, some or all of the blocks of the pre-boot process 400 may be performed manually and/or by some other device. Additionally, although the pre-boot process 400 is described with reference to the flowchart illustrated in FIG. 4, persons of ordinary skill in the art will readily appreciate that many other methods of performing the pre-boot process 400 may be used. For example, the order of many of the blocks may be altered, the operation of one or more blocks may be changed, blocks may be combined, and/or blocks may be eliminated. Furthermore, while the processes 400 and 416 are shown as being separate diagrams, those having ordinary skill in the art will readily recognize that the two processes could be combined and represented in a single diagram.

As will be readily appreciated by those having ordinary skill in the art, the boot block is a firmware portion that is executed when a processor (e.g., the processor 202) undergoes a reset. The pre-boot process 400 begins execution by starting initialization of the external memory (e.g., the RAM 206) (block 402). Some processors, for example, have a bit called MEMGO that can be modified to start the initialization of external memory. The memory initialization is a process that, once commenced, operates independently of the processor. Accordingly, the processor may continue with execution of the pre-boot process 400 as the memory is initializing.

After starting the external memory initialization (block 402), the pre-boot process 400 configures temporary memory (e.g., the cache 234) for stack and heap data storage (block 404). As will be readily appreciated by those having ordinary skill in the art, the processor 202 will autonomously evict (i.e., overwrite) portions of the cache 234 used as temporary memory unless configured in a no-eviction mode. Furthermore, upon storing stack and heap data in the cache for use by a high level language, evictions will result in the loss of key operational data. Due to the transitory nature of the cache as a data repository, care must be taken to set up the cache in a no-eviction mode.

After the temporary memory has been configured (block 404), a list of high level language modules to be executed is generated (block 406). Example modules that might be stored in the list are: a central processing unit (CPU) initialization module, a chipset initialization module, a board initialization module, etc. The list may be formed based on the unique pre-boot initialization requirements of the example processor system 200 of FIG. 2.

After the list of high level language modules for execution has been created (block 406), the pre-boot process 400 determines if there are additional high level language modules to be invoked (block 408). If no additional high level language modules are to be invoked (block 408), the pre-boot process 400 ends and/or returns control to any calling routines (block 410).

Conversely, if additional high level language modules are to be invoked (block 408), a high level language module from the list is invoked and consumed using the temp memory 104 of FIG. 1 (block 412). This list may be, for example, accomplished with a queue that removes a pointer to the high level language module from the queue upon invocation.

After the high level language module from the list is invoked and consumed (block 412), the pre-boot process 400 determines if main memory has completed its initialization (block 414). One way that the pre-boot process 400 may determine if main memory 106 of FIG. 1 is initialized, is for the processor 202 of FIG. 2 executing the pre-boot process 400 to receive an interrupt from a memory controller. Alternatively, the pre-boot process 400 may determine if main memory 106 of FIG. 1 is initialized by the processor 202 of FIG. 2 executing the pre-boot process 400 and then polling a memory location. If main memory has not completed its initialization (block 414), the pre-boot process 400 determines if there are additional modules to be invoked (block 408). The pre-boot process 400 continues to iterate execution through blocks 408, 412, and 414 until main memory is initialized.

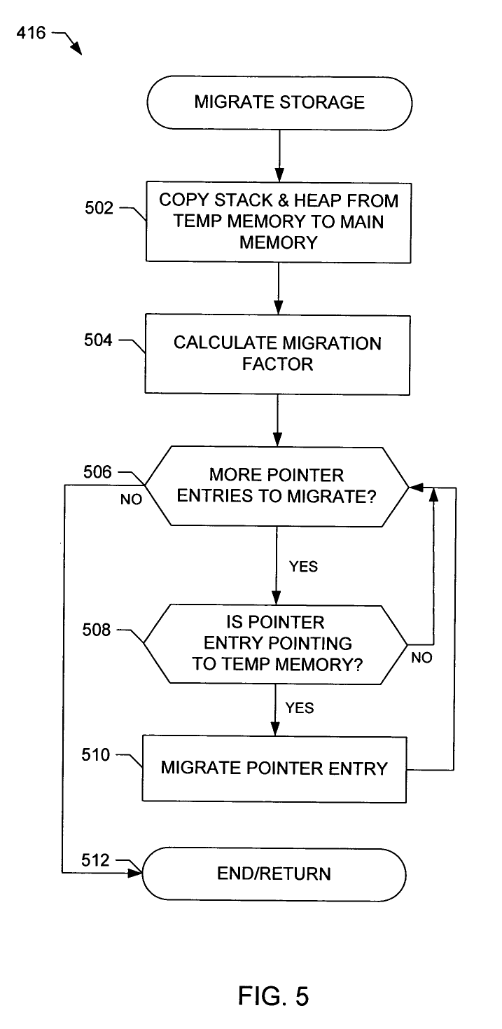

Conversely, if main memory has completed its initialization (block 414), a migrate storage process is started (block 416), which as described in conjunction with FIG. 5, transfers information from the temporary memory to the main memory. In contrast to invoking all modules using the temporary memory before determining if main memory is ready, this periodic determination allows for a quicker and more efficient transition to main memory. After the migrate storage process (block 416) has completed, the pre-boot process 400 ends and/or returns control to any calling routines (block 410).

As shown in FIG. 5, an example migrate storage process 416 begins by copying the stack and heap from the temporary memory to the main memory (block 502). Accordingly, many of the memory location references in the main memory will be identifying locations in the temporary memory that will subsequently be flushed. Alternatively or additionally, the temporary memory (e.g. the cache 234) may be flushed and put into eviction mode upon completion of block 502.

As with the pre-boot process 400, the migrate storage process 416 may be implemented using one or more software programs or sets of instructions that are stored in one or more memories (e.g., the memories 206, 208, 210) and executed by one or more processors (e.g., the processor 202). However, some or all of the blocks of the migrate storage process 416 may be performed manually and/or by some other device. Additionally, although the migrate storage process 416 is described with reference to the flowchart illustrated in FIG. 5, persons of ordinary skill in the art will readily appreciate that many other methods of performing the migrate storage process 416 may be used. For example, the order of many of the blocks may be altered, the operation of one or more blocks may be changed, blocks may be combined, and/or blocks may be eliminated.

After copying the temporary memory to main memory (block 502), a migration factor is calculated (block 504). An example algorithm for calculating the migration factor may be formulated by subtracting the value of the top of heap temp memory location 310 of FIG. 3 from the value of the top of heap main memory location 320 of FIG. 3.

After the calculation of the migration factor (block 504), the migrate storage process 416 determines if any/more pointer entries need to be migrated (block 506). If no more pointer entries to be migrated exist (block 506), then the migrate storage process 416 ends and/or returns control to any calling process 400 (block 512).

Conversely, if more pointer entries to be migrated exist (block 506), then the migrate storage process 416 determines if the pointer entry is pointing at a location within the temporary memory heap 308 of FIG. 3 (block 508). One possible implementation may be to check if the pointer value is greater than or equal to the value of the top of heap temporary memory location 310 of FIG. 3 and the pointer value is less than the value of the bottom of heap temporary memory 312 of FIG. 3. If the pointer entry is not pointing at a location within the temporary memory heap 308 of FIG. 3 (block 508), then the migrate storage process 416 determines if more pointer entries need to be migrated (block 506).

Conversely, if the pointer entry is pointing to a location within the temporary memory heap 318 of FIG. 3 (block 508), then the pointer entry is migrated (block 510). One possible implementation, which assumes that temporary memory is higher in memory than main memory, is to set the pointer to the pointer value minus the migration factor.

After the pointer entry is migrated (block 510), then the migrate storage process 416 determines if more pointer entries need to be migrated (block 506).

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

1. A method of migrating storage from a temporary memory location in a temporary memory to a main memory location in a main memory, the method comprising:
copying content from the temporary memory location to the main memory location;
calculating a migration factor between the temporary memory location and the main memory location; and
modifying a value in the main memory that identifies the temporary memory location to identify the main memory location.

2. A method as defined by claim 1, wherein the content comprises stack data.

3. A method as defined by claim 1, wherein the content comprises heap data.

4. A method as defined by claim 1, wherein the temporary memory comprises a cache memory.

5. A method as defined by claim 4, wherein the cache memory is flushed after the content from the temporary memory location is copied to the main memory location.

6. A method as defined by claim 4, wherein the cache memory is set to an eviction mode after the content from the temporary memory location is copied to the main memory.

7. A method as defined by claim 4, wherein the cache memory comprises one of (i) an L1 cache memory, and (ii) an L2 cache memory.

8. A method as defined by claim 1, wherein the temporary memory is cleared after the content from the temporary memory location is copied to the main memory location.

9. A method as defined by claim 1, wherein the main memory comprises a random access memory.

10. A method as defined by claim 1, wherein the migration factor is related to a difference between a temporary memory location and a main memory location.

11. A method as defined by claim 1, wherein the migration factor is equivalent to a difference between a temporary memory location and a main memory location.

12. A method as defined by claim 1, wherein the migration factor is related to a difference between a main memory location and a temporary memory location.

13. A method as defined by claim 1, wherein the migration factor is equivalent to a difference between a main memory location and a temporary memory location.

14. A method as defined by claim 1, wherein the value in the main memory is verified as identifying the temporary memory by determining if the value is greater than a bottom of the temporary memory and is less than a top of the temporary memory.

15. A method as defined by claim 1, wherein the copying of content from the temporary memory location to the main memory occurs during pre-boot.

16. An article of manufacture comprising a machine-accessible medium for use with a temporary memory having a temporary memory location and a main memory having a main memory location, the machine-accessible medium having a plurality of machine accessible instructions that, when executed, cause a machine to:
copy content from the temporary memory location to the main memory location;
calculate a migration factor between the temporary memory location and the main memory location; and
modify a value in the main memory that identifies the temporary memory location to identify the main memory location.

17. An article of manufacture as defined by claim 16, wherein the content comprises stack data.

18. An article of manufacture as defined by claim 16, wherein the content comprises heap data.

19. An article of manufacture as defined by claim 16, wherein the temporary memory comprises a cache memory.

20. An article of manufacture as defined by claim 19, wherein the cache memory is flushed after the content from the temporary memory location is copied to the main memory location.

21. An article of manufacture as defined by claim 19, wherein the cache memory is set to an eviction mode after the content from the temporary memory location is copied to the main memory.

22. An article of manufacture as defined by claim 19, wherein the cache memory comprises one of (i) an L1 cache memory, and (ii) an L2 cache memory.

23. An article of manufacture as defined by claim 16, wherein the temporary memory is cleared after the content from the temporary memory location is copied to the main memory location.

24. An article of manufacture as defined by claim 16, wherein the main memory comprises a random access memory.

25. An article of manufacture as defined by claim 16, wherein the migration factor is related to a difference between a temporary memory location and a main memory location.

26. An article of manufacture as defined by claim 16, wherein the migration factor is equivalent to a difference between a temporary memory location and a main memory location.

27. An article of manufacture as defined by claim 16, wherein the migration factor is related to a difference between a main memory location and a temporary memory location.

28. An article of manufacture as defined by claim 16, wherein the migration factor is equivalent to a difference between a main memory location and a temporary memory location.

29. An article of manufacture as defined by claim 16, wherein the value in the main memory is verified as identifying the temporary memory by determining if the value is greater than a bottom of the temporary memory and is less than a top of the temporary memory.

30. An article of manufacture as defined by claim 16, wherein the copying of content from the temporary memory location to the main memory occurs during pre-boot.

31. A system comprising:
a main memory having a main memory location;
a temporary memory having a temporary memory location;
a handler coupled to the main memory and the temporary memory, wherein the handler is configured to:
copy content from the temporary memory location to the main memory location;
calculate a migration factor between the temporary memory location and the main memory location; and
modify a value in the main memory that identifies the temporary memory location to identify the main memory location.

32. A system as defined by claim 31, wherein the content comprises stack data.

33. A system as defined by claim 31, wherein the content comprises heap data.

34. A system as defined by claim 31, wherein the temporary memory comprises a cache memory.

35. A system as defined by claim 34, wherein the cache memory is flushed after the content from the temporary memory location is copied to the main memory location.

36. A system as defined by claim 34, wherein the cache memory is set to an eviction mode after the content from the temporary memory location is copied to the main memory.

37. A system as defined by claim 34, wherein the cache memory comprises one of (i) an L1 cache memory, and (ii) an L2 cache memory.

38. A system as defined by claim 31, wherein the temporary memory is cleared after the content from the temporary memory location is copied to the main memory location.

39. A system as defined by claim 31, wherein the main memory comprises a random access memory.

40. A system as defined by claim 31, wherein the migration factor is related to a difference between a temporary memory location and a main memory location.

41. A system as defined by claim 31, wherein the migration factor is equivalent to a difference between a temporary memory location and a main memory location.

42. A system as defined by claim 31, wherein the migration factor is related to a difference between a main memory location and a temporary memory location.

43. A system as defined by claim 31, wherein the migration factor is equivalent to a difference between a main memory location and a temporary memory location.

44. A system as defined by claim 31, wherein the value in the main memory is verified as identifying the temporary memory by determining if the value is greater than a bottom of the temporary memory and is less than a top of the temporary memory.

45. A system as defined by claim 31, wherein the copying of content from the temporary memory location to the main memory occurs during pre-boot.
